(19) United States
(12) Patent Application Publication
(10) Pub. No.: US 2022/0314964 A1
(43) Pub. Date: Oct. 6, 2022

(54) Apparatus and System for Integrating An Electric Motor Into A Vehicle

(71) Applicant: Flux Hybrids Inc., Troutman, NC (US)

(72) Inventors: Cody Edward Biedermann, Troutman, NC (US); Clay Everett Dowdey, Troutman, NC (US); Justin Scott Care, Troutman, NC (US); Micah Stephen Ulrich, Troutman, NC (US)

(21) Appl. No.: 17/706,842

(22) Filed: Mar. 29, 2022

Related U.S. Application Data
(60) Provisional application No. 63/168,281, filed on Mar. 31, 2021.

(51) Int. Cl. B60W 20/40; B60W 10/08; B60W 10/02; B60W 30/18; B60W 50/02; F02N 11/04

(52) U.S. Cl. CPC B60W 20/40; B60W 10/08; B60W 10/02; B60W 30/18127; B60W 50/0205; F02N 11/04; B60W 2510/06; B60W 2510/10; B60W 2510/08; B60W 2510/02

(57) ABSTRACT

The apparatus and system for integrating an electric motor into a vehicle may convert a vehicle from an internal combustion vehicle to a hybrid-electric vehicle. One or more electric motors may be integrated into a powertrain between an internal combustion engine and a transmission. A supervisory controller may monitor and control operation of the internal combustion engine, clutching assembly, transmission, one or more electric motors, or any combination thereof to add mechanical power to the powertrain, remove mechanical power from the powertrain, or neutrally balance the transfer of mechanical power between the powertrain and the one or more electric motors. This conversion may be operable to produce torque from both internal combustion and electrical sources and may be operable to recover energy via regenerative braking. The conversion may be performed with little downtime and with the basic fundamental knowledge of a savvy car enthusiast.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### CROSS-REFERENCE TO RELATED APPLICATION

This application claims the benefit of priority to U.S. Provisional Application No. 63/168,281, entitled “System for Integrating Electric Motor into Vehicle”, filed Mar. 31, 2021, which is incorporated by reference herein in its entirety.

### BACKGROUND

Modern self-powered road vehicles commonly rely on internal combustion of combustible fuels to provide motive force for locomotion. Other technologies have emerged to reduce this reliance, and include hybrid-electric vehicles. Such vehicles include conventional internal combustion engines and electric motors. Hybrid-electric vehicles utilize this combined drivetrain to increase efficiency, using the electric motor for propulsion during a portion of the vehicle's drive cycle. Hybrids attain these increased efficiencies, therefore boosting fuel economy and lowering emissions, while still maintaining comparable performance to internal combustion vehicles.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a block diagram of a portion of a powertrain for a typical internal combustion vehicle according to the prior art.

FIG. 2 is a block diagram of a portion of a powertrain consistent with certain embodiments of the present invention, illustrating an electric motor in-line with the engine and transmission,

FIG. 3 is a block diagram of a portion of a powertrain consistent with certain embodiments of the present invention, illustrating a non-in-line electric motor coupled to a powertrain using a parallel torque transfer mechanism located downstream of the clutch assembly.

FIG. 4 is a block diagram of a portion of a powertrain consistent with certain embodiments of the present invention, illustrating a non in-line electric motor coupled to a powertrain using a parallel torque transfer mechanism located upstream of the clutch assembly.

FIG. 5 is a block diagram of a portion of a powertrain consistent with certain embodiments of the present invention, illustrating a combination of in-line and non in-line electric motors.

FIG. 6 is a side view of a portion of a powertrain consistent with certain embodiments of the present invention, illustrating the positioning of a displacement housing.

FIG. 7 is a block diagram of a portion of a powertrain consistent with certain embodiments of the present invention, illustrating a non in-line electric motor coupled to a powertrain using a perpendicular torque transfer mechanism.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

As used herein, “on-board diagnostics” (or OBD) may refer to a vehicle's self-diagnostic and reporting capability. The features, protocols, connectors, and other aspects of on-board diagnostics may be defined by one or more standards organization such as SAE and ISO. The term on-board diagnostics is intended to include the second generation of OBD (OBD-II) and any subsequent generations.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The apparatus and system for integrating an electric motor into a vehicle (hereinafter invention) may convert a vehicle from an internal combustion vehicle to a hybrid-electric vehicle. Specifically, the invention may integrate one or more electric motors into a powertrain between an internal combustion engine and a transmission. This conversion may be operable to produce torque from both internal combustion and electrical sources and may be operable to recover energy via regenerative braking. The conversion may be performed with little downtime and with the basic fundamental knowledge of a savvy car enthusiast.

Integrating the electric motor into the powertrain may comprise any or all of the exemplary non-limiting embodiments of locating the electric motor may be placed before or after the vehicle's torque converter. The vehicle's torque converter may be removed and replaced with a clutching assembly to facilitate placement of the electric motor. The transmission may be offset permanently from its normal location on the vehicle to facilitate placement of the electric motor where the offset may be configured to accommodate the engine compartment of a vehicle. The electric motor may be installed in place of a starter motor such that the existing starter motor may be removed and replaced by an electric motor in the same engine compartment.

Also, the electric motor may be installed directly in line with the drivetrain, or may be offset by the following means, such as in a parallel manner by some system of torque transfer including gears, belts and chains or in a perpendicular manner by bevel gear or some system of torque transfer including gears, belts, and chains. Where the gears, belts, and chains are configured to smoothly transfer power from the electric motor to the drivetrain in a customized configuration for the vehicle being converted. This customization of the configuration for a particular vehicle may involve some torque reduction or multiplication to take place in the in customized system of torque transfer, including gears, belts, and chains, that are installed. Additionally, as installed, the electric motor may be used to convert electrical power to mechanical power or mechanical power to electrical power through regenerative braking.

This integration may comprise any or all of the following control features:
Control software and/or electronics may be configured to control the installed electric motor so as to apply power, accept power, be placed in a stand by mode, or any combination thereof based upon the requirements of operation of the converted vehicle.
Where the clutching assembly is installed to facilitate installation of the electric motor, the electric motor may be utilized in the vehicle's starting sequence to apply additional torque.

Rather than developing and manufacturing hybrid-electric vehicles, conventional internal combustion powered vehicles may be converted into hybrid-electric vehicles. This conversion may reduce those vehicles' fuel consumption and emissions, as well as increasing reliability of certain components including the internal combustion engine and the braking system. These benefits may be of particular utility to commercial fleet vehicles, which may achieve those benefits without purchasing more expensive original equipment manufacturer (OEM) hybrid-electric vehicles.

A supervisory controller may receive input and/or vehicle status from the vehicle's Controller Area Network (CAN) bus via the on-board diagnostics (OBD) port or via other interfaces within the vehicle. As non-limiting examples, the other interfaces may comprise wiring and data lines located within the vehicle.

The supervisory controller may receive input from both factory installed and custom sensors. The supervisory controller may utilize an array of sensors, digital control wiring, and communication buses to monitor, diagnose, and actuate systems throughout the vehicle. Through the vehicle's On-Board Diagnostics (OBD-II) Protocol the supervisory controller can utilize the Controller Area Network bus to send/receive commands and data to ascertain the vehicle's operational parameters. As non-limiting examples, the operational parameters may comprise engine RPM, vehicle speed, torque, and so on.

The supervisory controller may be located anywhere within the body of the vehicle: wherever is convenient for mounting with protection from the elements. As a non-limiting example, the supervisory controller may be located within the passenger cabin for ease of access & convenience of servicing.

The supervisory controller may log the data that is acquired, may perform computations based upon the data, may process the data to adjust operational parameters within any system of the vehicle, may store the data, or any combination thereof. The acquired data may also be uploaded to a central location server utilizing one or more wireless communication links, non-limiting examples of which comprise WIFI, LTE, and Bluetooth protocols.

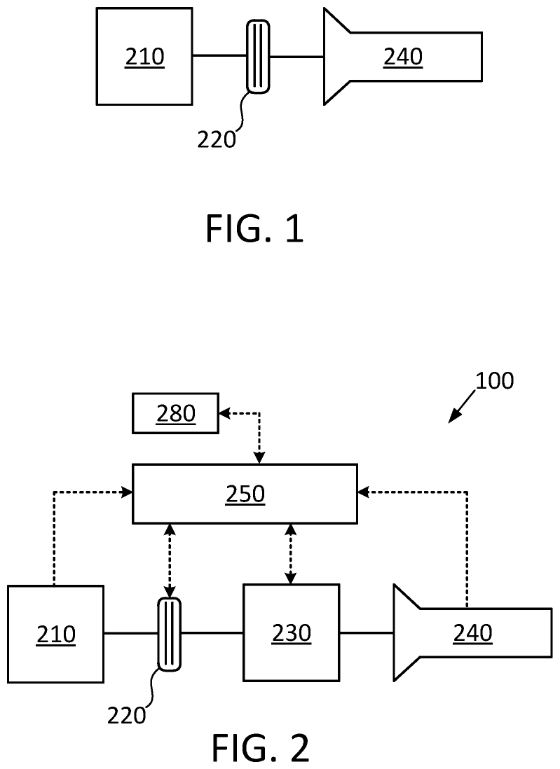

Turning now to FIG. 1, the figure shows the relevant components of a powertrain configuration that may be typical for conventional internal combustion powered vehicles. In general, an internal combustion engine 210 generates and provides torque to a torque converter or a clutching assembly 220, which then in turn provides torque to a transmission 240 when desired by the driver. The transmission 240, in turn, provides usable power to the vehicles' driven wheels.

The internal combustion vehicle of FIG. 1 may be converted into a hybrid-electric vehicle by introducing power from an electric motor 230 between the internal combustion engine 210 and the transmission 240. In some embodiments, the electric motor 230 may be directly in line with the internal combustion engine 210 and the transmission 240. In alternative embodiments, the electric motor 230 may not be in line with the internal combustion engine 210 and the transmission 240, however power from the electric motor 230 may be introduced between the internal combustion engine 210 and the transmission 240 via a torque transfer mechanism. As non-limiting examples, the torque transfer mechanism may utilize a belt and pulley, sprocket and chain, planetary gearset, or any combination thereof.

The conversion of an internal combustion vehicle into a hybrid-electric vehicle may generally include adding an electric motor, an energy storage system, and a controller into the vehicle. As non-limiting examples, the energy storage system may comprise one or more batteries, ultra-capacitors, fuel cells, or any combination thereof. By way of example and not of limitation, the controller may monitor vehicle conditions and may control power addition and subtraction. The electric motor may consist of at least one rotor and at least one stator and may both convert electricity into mechanical work and convert mechanical work into electricity. The general term motor used hereafter will refer to an assembly of one or more motors, combined by belt and pulley or sprocket and chain or planetary gearset or similar method. In some arrangements, the electric motor can be referred to as “traction motor”, “motor-generator”, etc. The conversion may additionally involve the removal of the base vehicle's torque converter and replacing it with a clutching assembly to facilitate the traction motor's placement. The general term clutching assembly used throughout may refer to any rotational disconnect system, including friction clutches, dog clutches, fluid coupling, or similar contrivances, or any combination thereof.

Turning to FIG. 2, the figure shows a vehicle converted to hybrid-electric by installing the electric motor 230 in line with the internal combustion engine 210 and the transmission 240, downstream of the clutching assembly 220 and downstream of the internal combustion engine 210. The electric motor 230 power addition and subtraction is optimally controlled by a supervisory controller 250, which takes inputs from the internal combustion engine 210, the clutching assembly 220, the electric motor 230, and the transmission 240 and provides outputs to the clutching assembly 220 and the electric motor 230. This configuration may require displacement of the transmission 240, in order to position the motor between the clutching assembly 220 and the transmission 240, where the transmission 240 is located further back on the vehicle.

FIG. 2 also illustrates a non-limiting example of how an energy storage system 280 may be coupled to store mechanical energy as electrical energy during braking. As a non-limiting example, during braking mechanical energy supplied from the wheels via the transmission 240 may rotate the electric motor 230, effectively turning the electric motor 230 into a generator. The supervisory controller 250 may utilize the electricity generated by the electric motor 230 to charge the energy storage system 280. The stored electric energy may be used at a later time to power the electric motor 230 and/or to power other electrical devices within the vehicle.

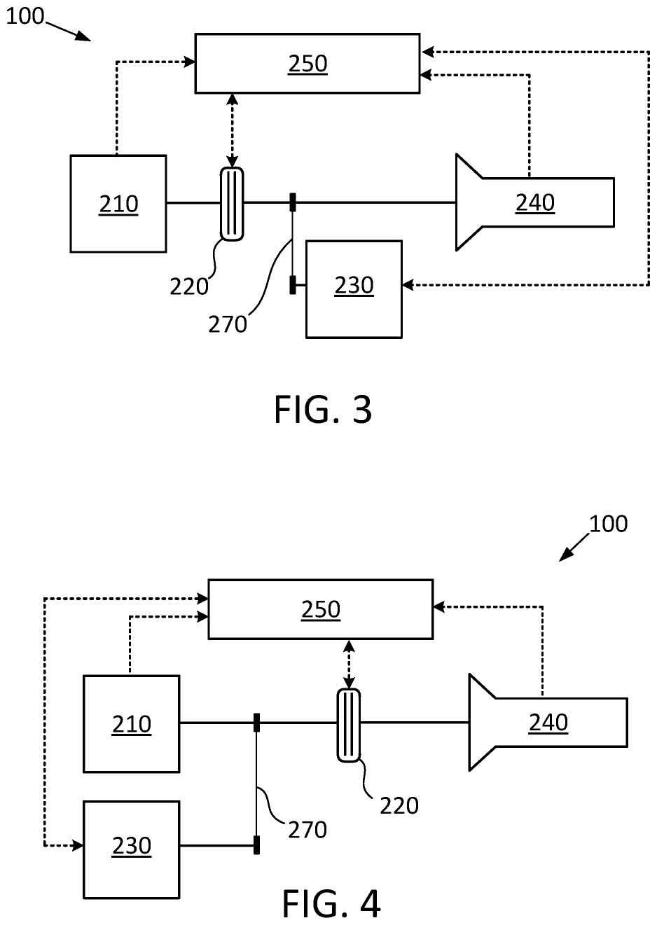

Turning to FIG. 3, the figure shows the vehicle converted in a similar fashion to that shown in FIG. 2, except that the electric motor 230 is not in-line with the internal combustion engine 210 and the transmission 240. Instead, torque from the electric motor 230 may be introduced between the internal combustion engine 210 and the transmission 240 by coupling the electric motor 230 to the internal combustion engine 210 via a parallel torque transfer mechanism 270. As non-limiting examples, the parallel torque transfer mechanism 270 may comprise gears, chains, pulleys, belts, or any combination thereof. This configuration may allow for the conversion into a hybrid-electric with less displacement of the transmission 240.

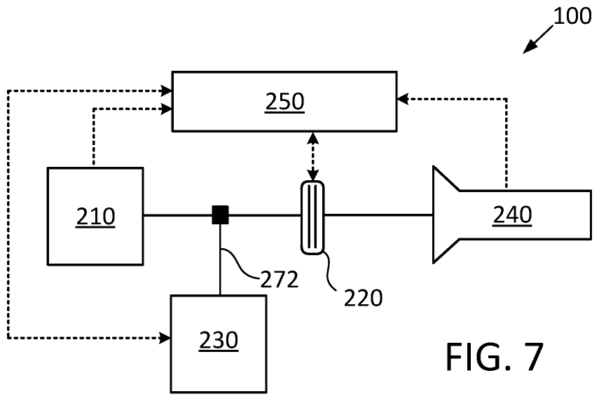

Alternatively, the electric motor 230 may be coupled to the internal combustion engine 210 via a perpendicular torque transfer mechanism 272 as shown in FIG. 7. As a non-limiting example, the perpendicular torque transfer mechanism 272 may comprise bevel gears or other gears, belts, chains, or any combination thereof.

Turning to FIG. 4, the figure shows the vehicle converted in a similar fashion to that shown in FIG. 3, except that the electric motor 230 is located upstream of the clutching assembly 220. This configuration may allow for the vehicle's starter motor to be removed, potentially freeing up space that may facilitate installation of the electric motor 230. This configuration may additionally allow for simpler idle mitigation capabilities. With idle mitigation capabilities, the supervisory controller 250 may have the ability to output to turn the internal combustion engine 210 off and on. As a non-limiting example, turning the internal combustion engine 210 off and on may allow the supervisory controller 250 to optimize fuel economy and/or other engine parameters.

This disclosure should not be construed to imply that only a single electric motor may be integrated. As a non-limiting example, one or more electric motors may be coupled both upstream and downstream of the clutching assembly 220 for different purposes. Neither should the disclosure be construed to imply that all electric motors must be integrated in the same manner, such as in line, using the parallel torque transfer mechanisms 270, or using the perpendicular torque transfer mechanism 272 as shown in FIG. 7.

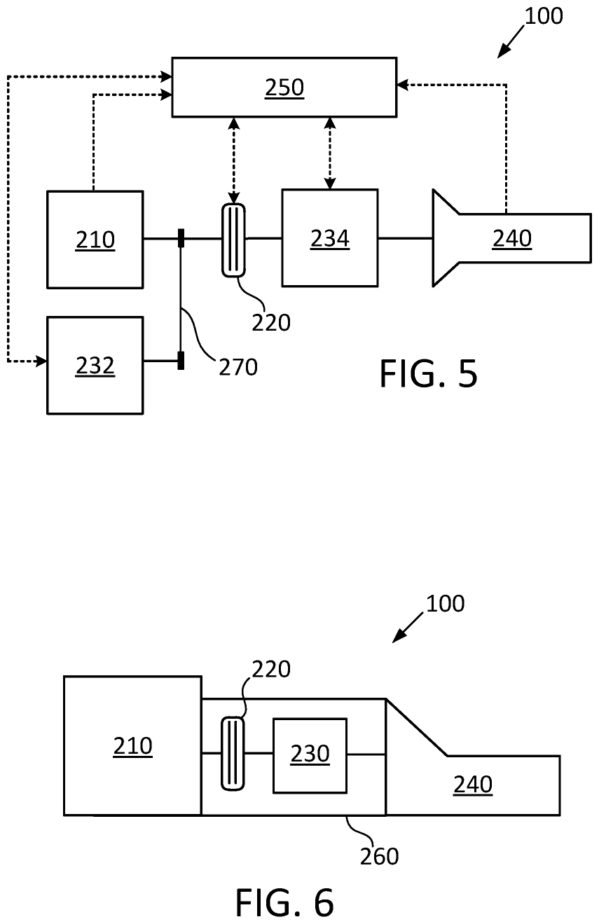

Turning to FIG. 5, the figure shows the vehicle converted in a combinatorial fashion with respect to the configurations shown in FIG. 2 and FIG. 4. By having a first electric motor 232 installed upstream of the clutching assembly 220, idle mitigation as previously described is made possible. In addition, a second electric motor 234 may be installed downstream of the first electric motor 232 to provide additional power.

Turning to FIG. 6, the figure shows a non-limiting example of how the transmission of a vehicle may be displaced to provide additional space for conversion when the transmission bellhousing does not provide sufficient space for conversion components. In some embodiments, if the transmission is displaced past a certain point, then wiring, coolant lines, and additional infrastructure may need to be extended and hardware such as mounting brackets may require additional reconfiguration. A displacement housing 260 may be installed between the internal combustion engine 210 and the transmission 240 to provide structural rigidity and to protect conversion components including the electric motor 230 and the clutching assembly 220. Additionally, the vehicle's flex plate or flywheel may be modified to increase the amount of space available, with or without a displaced transmission.

Turning to FIG. 7, the figure shows the vehicle converted in a similar fashion to that shown in FIG. 4, except that the electric motor 230 is coupled to the powertrain via the perpendicular torque transfer mechanism 272. This configuration may be less preferable that the configuration of FIG. 4 due to packaging constraints, however this configuration does retain most of the advantages of the configuration of FIG. 4 including the ability to utilize the electric motor 230 as the starter motor.

While certain illustrative embodiments have been described, it is evident that many alternatives, modifications, permutations and variations will become apparent to those skilled in the art in light of the foregoing description.

What is claimed is:

1. An apparatus comprising
one or more electric motors and a supervisory controller;
where the one or more electric motors are installed into an existing vehicle and are coupled to a powertrain at a point located between an internal combustion engine and a transmission;
where the supervisory controller monitors the operation of the internal combustion engine, the transmission, the one or more electric motors, and a clutching assembly;
where the supervisory controller adjusts the operation of the one or more electric motors and the clutching assembly.

2. The apparatus according to claim 1
where at least one of the one or more electric motors is coupled in line with the internal combustion engine and the transmission.

3. The apparatus according to claim 1
where at least one of the one or more electric motors is coupled to the powertrain via a torque transfer mechanism that transfers power between the at least one of the one or more electric motors and the powertrain.

4. The apparatus according to claim 3
where the torque transfer mechanism is a parallel torque transfer mechanism.

5. The apparatus according to claim 3
where the torque transfer mechanism is a perpendicular torque transfer mechanism.

6. The apparatus according to claim 1
where at least one of the one or more electric motors is coupled to the powertrain at a point located between the internal combustion engine and the transmission and downstream of the clutching assembly such that the at least one of the one or more electric motors is utilized for regenerative braking.

7. The apparatus according to claim 1
where at least one of the one or more electric motors is coupled to the powertrain at a point located between the internal combustion engine and the transmission and upstream of the clutching assembly such that the at least one of the one or more electric motors is operable as a starter motor.

8. The apparatus according to claim 1
further comprising a displacement housing to provide structural rigidity and to protect conversion components including the one or more electric motors and the clutching assembly.

9. The system according to claim 1
where the supervisory controller receives input and/or vehicle status from the vehicle's Controller Area Network (CAN) bus via an on-board diagnostics (OBD) port or via other interfaces within the vehicle.

10. A system comprising
one or more electric motors and a supervisory controller;
where the one or more electric motors are installed within and existing vehicle and coupled to a powertrain at a point located between an internal combustion engine and a transmission;
where the supervisory controller monitors the operation of the internal combustion engine, the transmission, the one or more electric motors, and a clutching assembly;
where the supervisory controller adjusts the operation of the one or more electric motors and the clutching assembly;
where the supervisory controller adjusts the operation of the one or more electric motors to add mechanical power to the powertrain by transferring mechanical power from the one or more electric motors to the powertrain, adjusts the operation of the one or more electric motors to subtract mechanical power from the powertrain by transferring mechanical power from the powertrain to the one or more electric motors, neutrally balances the transfer of mechanical power such that no mechanical power is transferred between the one or more electric motors and the powertrain, or any combination thereof.

11. The system according to claim 10
where the supervisory controller adjusts the clutching assembly during braking to decouple the transmission from the internal combustion engine and transfer mechanical power from the rear wheels to at least one of the one or more electric motors via the transmission such that the at least one of the one or more electric motors converts the mechanical power into electrical power which the supervisory controller routes to an energy storage system.

12. The system according to claim 10
where the supervisory controller adjusts the clutching assembly during engine starts to decouple the transmission from the internal combustion engine and utilizes at least one of the one or more electric motors as a starter motor.

13. The system according to claim 10
where the supervisory controller receives input and/or vehicle status from the vehicle's Controller Area Network (CAN) bus via an on-board diagnostics (OBD) port or via other interfaces within the vehicle.
